(19) United States
(12) Patent Application Publication
(10) Pub. No.: US 2026/0065354 A1
(43) Pub. Date: Mar. 5, 2026

(54) METHOD AND DEVICE FOR REDUCING ONLINE SHOPPING RETURNS

(71) Applicant: MOTOROLA MOBILITY LLC, WILMINGTON, DE (US)

(72) Inventors: KRISHNAN RAGHAVAN, BANGALORE (IN); NAKUL PATEL, NAGPUR (IN); PRASAD A G, BANGALORE (IN)

(21) Appl. No.: 18/824,299

(22) Filed: Sep. 4, 2024

(51) Int. Cl. G06Q 30/0601; G06Q 30/0204

(52) U.S. Cl. CPC G06Q 30/0641; G06Q 30/0204

(57) ABSTRACT

An electronic device, a method and a computer program product for reducing incidents of returns of purchased/requested items. The method includes detecting a trigger indicative of an item review context that includes a first item which was previously acquired by a previous consumer. In response to detecting the trigger, the method includes retrieving customer return data corresponding to the first item and retrieving user preferences profile data correlated to acquiring items within a merchandise category. The method includes determining if the customer return data indicates that the first item has a first return rate within a demographic of previous consumers having similar profiles. In response to the first item having the first return rate, the method includes outputting an indication or message concurrently with presenting the first item for review or selection. The first message indicates the first return rate of the first item.

### BACKGROUND

### 1. Technical Field

The present disclosure generally relates to electronic devices and in particular to using electronic devices to facilitate online shopping.

### 2. Description of the Related Art

Electronic devices, such as mobile phones, tablets, and laptops, are widely used for video, voice, and text communication and for data transmission. Online shopping has also become a popular use for these mobile electronic devices. Online shopping is a form of electronic commerce that allows consumers to purchase goods or services using an electronic device. Consumers can find a product of interest by visiting retailer websites or by using a search engine that displays the availability and price of a product at different merchants. The consumer can then complete the purchase of the product using their electronic device.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example electronic device within which various aspects of the disclosure can be implemented, according to one or more embodiments;

FIG. 2 is an example illustration of the electronic device of FIG. 1 transmitting a request for customer return data to an application computer system and a receiving a response from the application computer system, according to one or more embodiments;

FIGS. 3A and 3B are block diagrams of example contents of the system memory of the example electronic device of FIG. 1 configured to complete the various processes described herein, according to one or more embodiments;

FIG. 4 is an example illustration of a display of an electronic device presenting an online item selection graphical user interface (GUI) including a return rate message indicating a return rate of at least one previously-acquired item, according to one or more embodiments;

FIG. 5A is an example illustration of a display of an electronic device presenting an online item selection GUI including a user-selectable option to present a message indicating a return rate of at least one previously-acquired item, according to one or more embodiments;

FIG. 5B is an example illustration of a display of an electronic device presenting an online item selection GUI including a return rate message, after the user-selectable option of FIG. 5A has been selected, according to one or more embodiments;

FIG. 6A is an example illustration of a display of an electronic device presenting an online item selection GUI including a user-selectable option to present alternative product recommendations with lower return rates, according to one or more embodiments;

FIG. 6B is an example illustration of a display of an electronic device presenting an online item selection GUI including alternative product recommendations, after the user-selectable option of FIG. 6A has been selected, according to one or more embodiments;

FIG. 7A is an example illustration of a display of an electronic device presenting a filter selection GUI for selecting one or more filter types to be applied to an online item selection GUI, according to one or more embodiments;

FIG. 7B is an example illustration of a display of an electronic device presenting an online item selection GUI after the filter of FIG. 7A has been applied, according to one or more embodiments;

FIG. 8 depicts a flowchart of a method by which an electronic device presents a return rate message with a return rate of at least one item that was previously-acquired, according to one or more embodiments; and

FIG. 9 depicts a flowchart of a method by which an electronic device identifies and presents alternative products/items with return rates below a return rate threshold, according to one or more embodiments.

### DETAILED DESCRIPTION

According to one or more aspects of the disclosure, the illustrative embodiments provide an electronic device, a method, and a computer program product for reducing incidents of returns of purchased/requested items.

Products or items are often purchased via online shopping. Electronic commerce has traditionally incurred a higher return rate than physical stores. The main reason for the higher return rate is the inability of online consumers to view and try products in advance, increasing the likelihood of incorrect purchases. High return rates are a problem faced by many online retailers. Lower return rates of purchased items correspond to more satisfied customers and increased profitability for the online retailer. Unfortunately, when a customer purchases products, such as clothing, via online shopping, there can be issues with fit, size, color, material, and style that result in the products being returned to the online retailer. The present disclosure addresses and resolves the problem of high return rates for items purchased via online shopping. The disclosure provides a user of an electronic device who is interested in purchasing an item/product with additional information regarding return rates and return rate context to help guide decisions about which products to purchase.

In a first embodiment, an electronic device includes at least one output device, including a display, a communications subsystem that enables the electronic device to connect to external networks and devices, and a memory having stored thereon a return reduction module that includes executable code for reducing incidents of returns of purchased/requested items. The electronic device includes at least one processor that is communicatively coupled to each of the at least one output device, the communications subsystem, and the memory, and which executes program code of the return reduction module. The at least one processor is configured to cause the electronic device to detect a trigger indicative of an item review context that includes a presentation of at least one first item having a first merchandise category and which was previously acquired by a previous consumer. In response to detecting the trigger, the at least one processor retrieves customer return data corresponding to the at least one first item and retrieves user preferences profile data correlated to acquiring items within the first merchandise category. The at least one processor determines if the customer return data indicates that the at least one first item has a first return rate within a demographic of previous consumers having similar profiles as that presented by the user preferences profile data. In response to the at least one first item having the first return rate, the at least one processor outputs at least one of an indication or a first message, concurrently with presenting the at least one first item for review or selection. The indication or first message indicates the first return rate of the at least one first item.

According to another embodiment, the method includes detecting, via at least one processor, a trigger indicative of an item review context that includes a presentation of at least one first item having a first merchandise category and which was previously acquired by a previous consumer. In response to detecting the trigger, the method includes retrieving customer return data corresponding to the at least one first item and retrieving user preferences profile data correlated to acquiring items within the first merchandise category. The method includes determining if the customer return data indicates that the at least one first item has a first return rate within a demographic of previous consumers having similar profiles as that presented by the user preferences profile data. In response to the at least one first item having the first return rate, the method includes outputting at least one of an indication or a first message, concurrently with presenting the at least one first item for review or selection. The indication or first message indicates the first return rate of the at least one first item.

According to an additional embodiment, a computer program product includes a computer readable storage device having stored thereon program code that, when executed by at least one processor of an electronic device having at least one output device and a communications subsystem, the program code enables the electronic device to complete the functionality of the above-described method processes.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

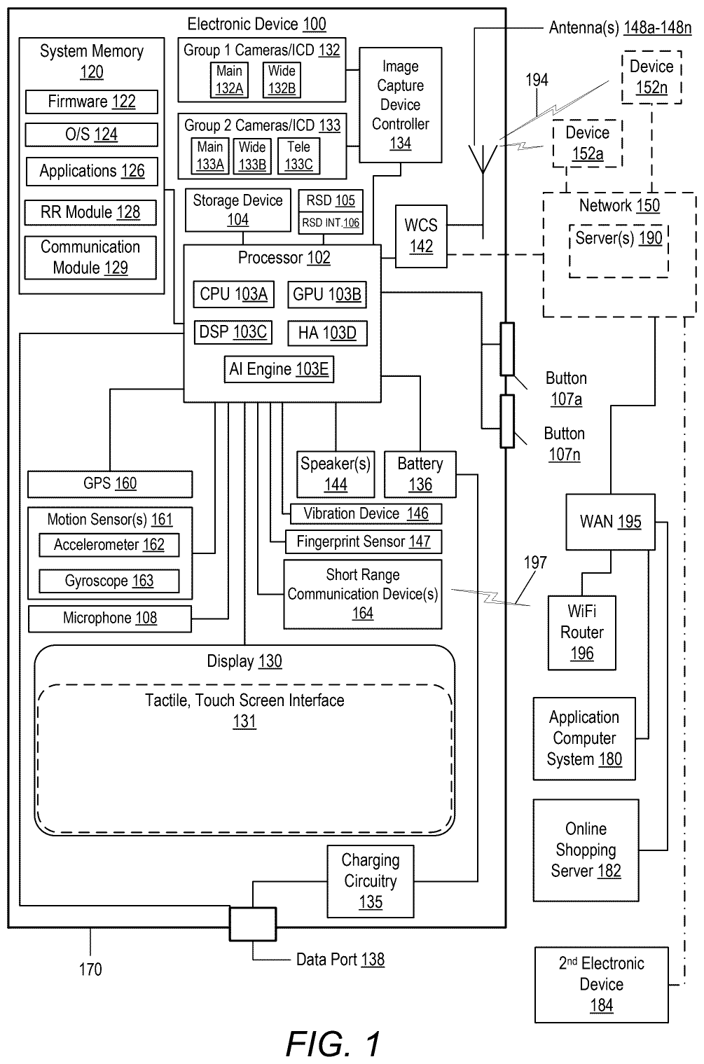

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

FIG. 1 depicts an example electronic device 100 within which various aspects of the disclosure can be implemented, according to one or more embodiments. Examples of such electronic devices include, but are not limited to, mobile devices, a notebook computer, a mobile phone, a digital camera, a smart watch, a tablet computer, and a communication device, etc. It is appreciated that electronic device 100 can be other types of devices that include the capability to transmit and receive communications. Electronic device 100 includes processor 102, which is communicatively coupled to storage device 104, system memory 120, input devices, (introduced below), output devices, such as display 130, and image capture device (ICD) controller 134. In one or more embodiments, the functionality of ICD controller 134 is incorporated within processor 102, eliminating the need for a separate ICD controller. For simplicity in describing the features presented herein, the various camera control functions performed by the ICD controller 134 are described as being provided generally by processor 102. Processor 102 can include processor resources such as a primary central processing unit (CPU) 103A that supports computing, classifying, processing and transmitting of data and information. Processor 102 can further include graphic processing units (GPU) 103B, digital signal processors (DSP) 103C, and hardware accelerator (HA) 103D that that also support computing, classifying, processing and transmitting and receiving of data and information. Processor 102 can further include a hardware based artificial intelligence (AI) engine 103E. AI engine 103E accelerates artificial intelligence, natural language processing (NLP), context evaluation (CE), and machine learning applications. AI engine 103E can also be implemented via a software module, in one embodiment.

System memory 120 may be a combination of volatile and non-volatile memory, such as random access memory (RAM) and read-only memory (ROM). System memory 120 can store program code and data associated with firmware 122, an operating system 124, applications 126, return reduction (RR) module 128, and communication module 129. Return reduction module 128 includes program code that is executable by processor 102 and configures processor 102 to cause/enable electronic device 100 to present item return data that results in reduced incidents of returns of purchased/requested items. Communication module 129 includes program code that is executed by processor 102 and configures processor 102 to cause/enable electronic device 100 to communicate with other external devices and systems.

Although depicted as being separate from applications 126, return reduction module 128, and communication module 129 may each be implemented as an application. Processor 102 loads and executes program code stored in system memory 120, including program code associated with applications 126 and program code associated with return reduction module 128 and communication module 129. When processed/executed by processor 102, the program code causes or configures electronic device 100 to provide the various functionality described herein.

In one or more embodiments, electronic device includes removable storage device (RSD) 105, which is inserted into an RSD interface 106 that is communicatively coupled via system interlink to processor 102. In one or more embodiments, RSD 105 is a non-transitory computer program product or computer readable storage device. In one or more embodiments, RSD 105 is a computer readable storage device encoded with program code and corresponding data, and RSD 105 can interchangeably be referred to as a non-transitory computer program product. RSD 105 may have a version of return reduction module 128 stored thereon, in addition to other program code. Processor 102 can access RSD 105 to provision electronic device 100 with program code that, when executed by processor 102, causes or configures electronic device 100 to provide the functionality described herein.

Display 130 can be one of a wide variety of display screens or devices, such as a liquid crystal display (LCD) and an organic light emitting diode (OLED) display. In some embodiments, display 130 can be a touch screen device that can receive user tactile/touch input. As a touch screen device, display 130 includes a tactile, touch screen interface 131 that allows a user to provide input to or to control electronic device 100 by touching features presented within/below the display screen. Tactile, touch screen interface 131 can be utilized as an input device.

Throughout the disclosure, the term image capturing device (ICD) is utilized interchangeably to be synonymous with and/or refer to any one of group 1 cameras/ICD 132, and group 2 cameras/ICD 133. As illustrated, electronic device 100 includes several front cameras/ICD 132. Electronic device 100 further includes several back/rear cameras/ICD 133. Front cameras/ICD 132 can include a main camera 132A and a wide angle camera 132B. Back cameras/ICD 133 can include a main camera 133A, a wide angle camera 133B, and a telephoto camera 133C. Each front camera 132A and 132B and each back camera 133A, 133B and 133C is communicatively coupled to ICD controller 134, which is communicatively coupled to processor 102 (or integrated within processor 102). ICD controller 134 supports the processing of image data from front cameras 132A and 132B and back cameras 133A, 133B, and 133C.

Electronic device 100 can further include charging circuitry 135, battery 136, and data port 138, for providing electrical power to the various electronic components of electronic device 100. Electronic device 100 further includes microphone 108, one or more output devices such as speaker 144, and one or more input buttons 107a-n. Input buttons 107a-n may provide controls for volume, power, and/or image capture devices 132, 133. Microphone 108 can also be referred to as audio input device 108. Microphone 108 can be used to receive audible biometric data (i.e., speech) to identify or authenticate a user. Microphone 108 and input buttons 107a-n can also be referred to generally as input devices. Speaker 144 can provide an audio alert or other audio output to a user.

Electronic device 100 further includes wireless network communication subsystem (WNCS) 142, which is coupled to antennas 148a-148n. In one or more embodiments, WNCS 142 can include a communication module with one or more baseband processors or digital signal processors, one or more modems, and a radio frequency front end having one or more transmitters and one or more receivers. Wireless network communication subsystem (WNCS) 142 and antennas 148a-148n allow electronic device 100 to communicate wirelessly with wireless network 150 via transmissions of communication signals 194 to and from network communication devices 152a-152n, such as base stations or cellular nodes, of wireless network 150.

In one or more embodiment, wireless network 150 can include one or more servers 190 that support wireless exchange of voice, data, and video and other communication with electronic device 100. Wireless network 150 further allows electronic device 100 to communicate with application computer system 180, online shopping server 182, and second electronic device 184. Application computer system 180 and online shopping server 182 are communicatively coupled to wireless network 150 via a wide area network (WAN) 195, such as the Internet. In an embodiment, servers 190 of wireless network 150 support wireless exchange of e-mail, text, data, and other communications between electronic device 100 and application computer system 180 and online shopping server 182. In one embodiment, application computer system 180 and online shopping server 182 can provide data, information, and resources to electronic device 100 for use with applications 126 and return reduction module 128.

Second electronic device 184 is also communicatively coupled to wireless network 150. Second electronic device 184 can be similarly connected to wireless network 150, via one of network communication devices 152a-152n. In an embodiment, servers 190 of wireless network 150 support wireless exchange of voice, text, data, and video and other communication between electronic device 100 and second electronic device 184.

Electronic device 100 further includes short range communication device(s) 164. Short-range communication device 164 is a low powered transceiver that can wirelessly communicate with other devices. Short-range communication device(s) 164 can include one or more of a variety of devices supporting different corresponding wireless protocols, such as a near field communication (NFC) device, a Bluetooth device, and/or a wireless fidelity (Wi-Fi) device. Electronic device 100 can also connect wirelessly to wireless network 150 via communication signals 197 transmitted by short-range communication device(s) 164 to and from WiFi router 196, which is communicatively coupled to WAN 195, such as the Internet. Wireless network 150 is communicatively coupled to WAN 195.

Short-range communication device(s) 164 can wirelessly communicate with WiFi router 196 via communication signals 197. In one embodiment, electronic device 100 can receive Internet or Wi-Fi based calls via short-range communication device(s) 164. In one embodiment, electronic device 100 can communicate with WiFi router 196 wirelessly via short-range communication device(s) 164. In an embodiment, WNCS 142, antennas 148a-148n, and short-range communication device(s) 164 collectively provide a communications subsystem of electronic device 100.

Electronic device 100 further includes vibration device 146, fingerprint sensor 147, global positioning system (GPS) 160, and motion sensor(s) 161. Vibration device 146 can cause electronic device 100 to vibrate or shake when activated. Vibration device 146 can be activated to provide an alert or notification to a user of electronic device 100. According to one aspect of the disclosure, display 130, speakers 144, and vibration device 146 can generally and collectively be referred to as output devices. These output devices can be each utilized to present different alerts and other information to the user.

Fingerprint sensor 147 can be used to provide biometric data or images to identify or authenticate a user. GPS 160 can provide time data and location data about the physical location of electronic device 100. In one embodiment, GPS 160 uses data from geospatial input received from GPS satellites. Location information and data received from GPS 160 can be utilized to identify a location of an electronic device.

Motion sensor(s) 161 can include one or more accelerometers 162 and gyroscope 163. Motion sensor(s) 161 can detect movement of electronic device 100 and provide motion data to processor 102 indicating the spatial orientation and movement of electronic device 100. Accelerometers 162 measure linear acceleration of movement of electronic device 100 in multiple axes (X, Y and Z). For example, accelerometers 162 can include three accelerometers, where one accelerometer measures linear acceleration in the X axis, one accelerometer measures linear acceleration in the Y axis, and one accelerometer measures linear acceleration in the Z axis. Gyroscope 163 measures rotation or angular rotational velocity of electronic device 100. Electronic device 100 further includes a housing 170 that contains the components of electronic device 100. Housing 170 presents a front side and a back side of electronic device, with cameras and display device(s) embedded in respective ones of the front side or back side of housing 170.

In the description of each of the following figures, reference is also made to specific components illustrated within the preceding figure(s). Similar or same components are presented with the same leading reference number.

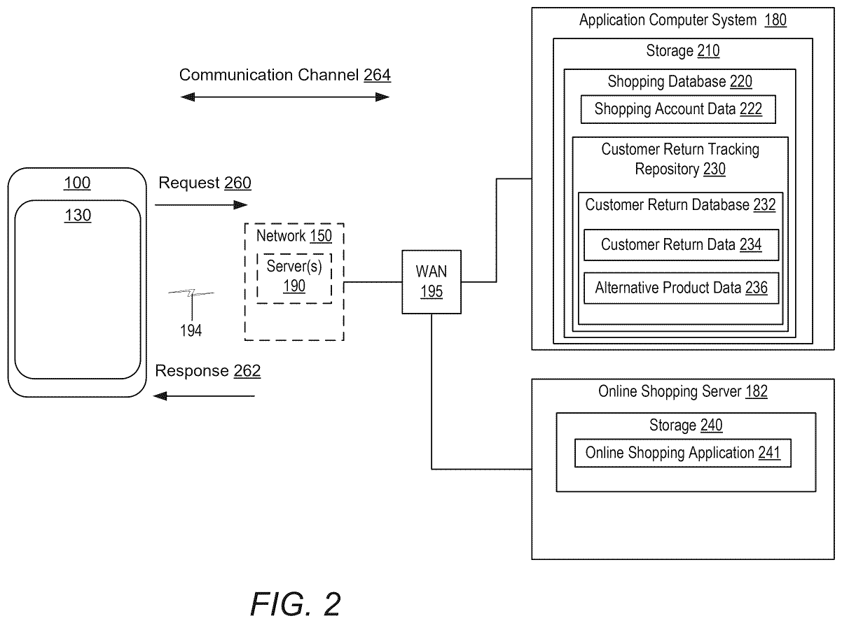

Turning to FIG. 2, with ongoing reference to FIG. 1, electronic device 100 is shown in communication with application computer system 180 and online shopping server 182. Electronic device 100 can communicate wirelessly with wireless network 150 via transmission and reception of communication signals 194. Communication network 150 includes communication servers 190 that are communicatively connected to a larger, wide area network (WAN) 195, such as the Internet. Electronic device 100 can also establish connection and communicate with wireless network 150 and with WAN 195 via WiFi router 196 and short-range communication device(s) 164 (FIG. 1).

Application computer system 180 and online shopping server 182 are communicatively coupled to a wide area network (WAN) 195, such as the Internet, to which server 190 of wireless network 150 is also communicatively coupled. In an embodiment, servers 190 of wireless network 150 support wireless exchange of e-mail, text, data, and other communication between electronic device 100 and application computer system 180 and online shopping server 182

Application computer system 180 can host one or more applications that provide various functions. In an example embodiment, application computer system 180 can host shopping applications, banking applications, and web browser applications. Application computer system 180 includes storage 210, such as one or more hard drives or solid state drives. Storage 210 can store shopping database 220. Shopping database 220 can support one or more applications 126 of electronic device 100.

Shopping database 220 includes shopping account data 222 and customer return tracking repository 230. Customer return tracking repository 230 includes a customer return database 232, which stores customer return data 234 and alternative product data 236. Shopping account data 222 can include user account data, merchant information, preferred payment methods, and preferred shipping/delivery methods. Customer return data 234 includes information about items that have been returned to an online retailer or merchant by previous customers.

In an embodiment, customer return data 234 can be updated with information about item returns from customers that were previously acquired by a previous consumer and/or the current user. In one embodiment, customer return data 234 can include user preferences profile data that is correlated to acquiring items within a first merchandise category. In one embodiment, customer return data 234 can include one or more reasons for returning an item, a length of time an item was kept before returning, and context provided by previous customer about item returns. In one embodiment, customer return data 234 can include return rates within a demographic of previous consumers having similar profiles as that presented by the user preferences profile data.

Alternative product data 236 include products that have a common merchandise category with an item being reviewed and a return rate that is less than a return rate threshold. Alternative product data 236 includes at least one alternative previously-acquired item with better customer return ratings. In one embodiment, alternative product data 236 can include alternative product recommendations for substantially all items/products that are sold by an online merchant.

According to one aspect of the disclosure, electronic device 100 can generate a request 260 for customer return data 234 for a particular item or product. Electronic device 100 transmits the request 260 to customer return tracking repository 230. Electronic device 100 receives, from the customer return tracking repository 230, response 262 with the customer return data 234.

In one or more embodiments, the initiation/activation of at least one shopping application by/on electronic device 100, which presents access to purchase or acquire items/products, can trigger establishment of a communication channel 264 with application computer system 180 to facilitate transmission of request 260 to application computer system 180 for customer return data 234. The review of items available for acquisition can serve/operate as a trigger that causes electronic device 100 to transmit request 260. Other triggers are possible, including establishment of communication channel 264 with application computer system 180. Electronic device 100 can receive, in response to the request 260, a response 262 from customer return tracking repository 230 that contains customer return data 234 for a selected/specific item/product. Electronic device 100 and application computer system 180 can perform a validation and authentication routine prior to the exchange of data and information to provide account verification and security for secure access by the electronic device to customer return tracking repository 230.

Online shopping server 182 can host one or more third party shopping applications 241 that provide access to goods and services. Online shopping server 182 includes storage 240, such as one or more hard drives or solid state drives. Storage 240 can store online shopping application 241 and, in one embodiment, a local version of customer return tracking repository for the particular online shopping site. In one or more embodiments, application computer system 180, at least in parts or whole, can be implemented within/by online shopping server 182.

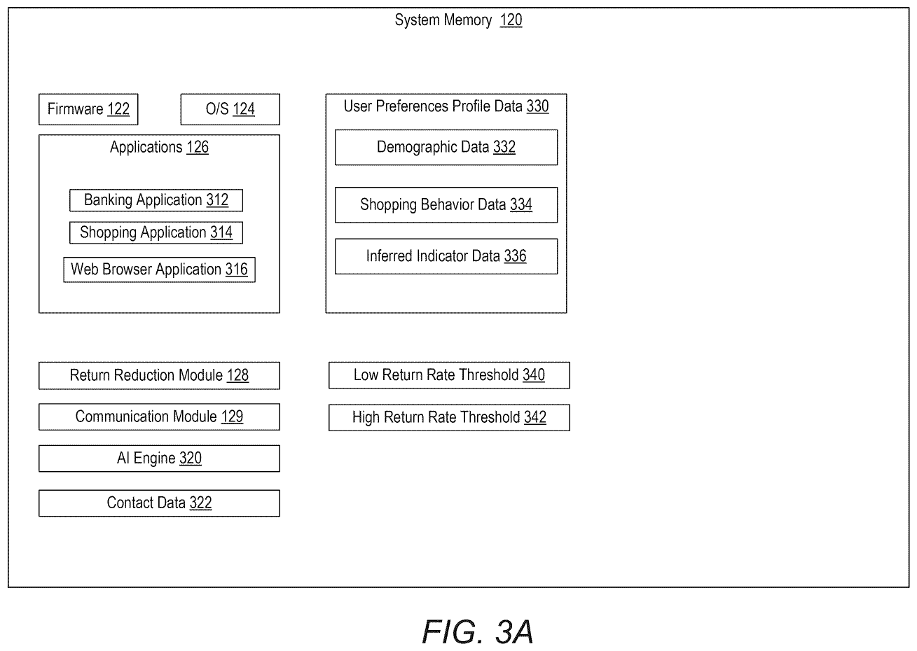

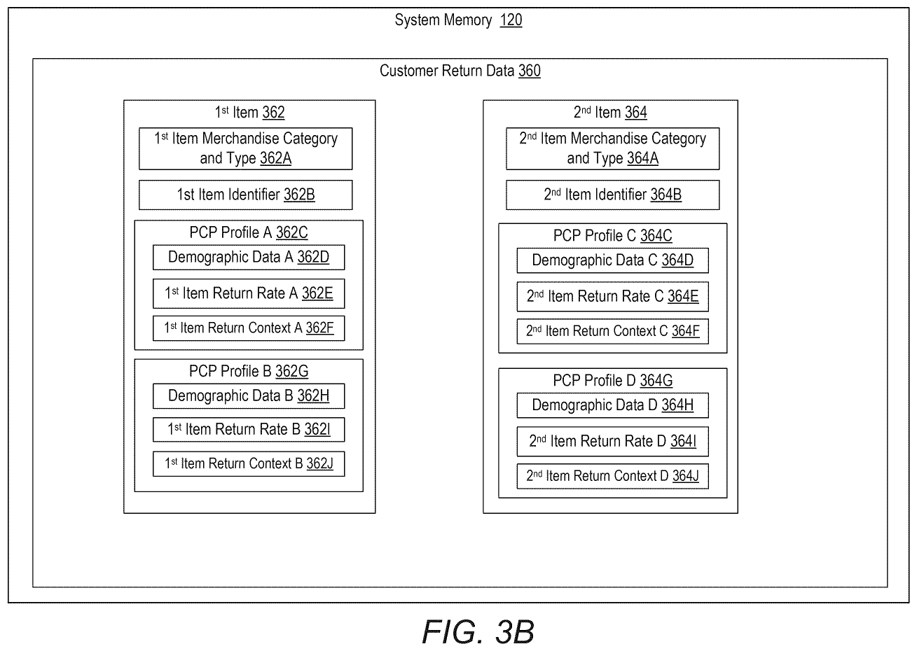

Referring to FIG. 3A, there is shown one embodiment of example contents of system memory 120 of electronic device 100 configured to complete the various processes described herein. System memory 120 includes data, software, and/or firmware modules, including firmware 122, an operating system (O/S) 124, applications 126, return reduction module 128, and communication module 129. Applications 126 include banking application 312, shopping application 314, and web browser application 316. Banking application 312 includes program code that is executed by processor 102 to enable electronic device 100 to access banking services provided by a bank or other financial institution, such as a credit card company, online payment service, etc. Shopping application 314 includes program code that is executed by processor 102 to enable electronic device 100 to access websites to view, browse and buy products or services from a retailer or service provider. Web browser application 316 includes program code that is executed by processor 102 to enable electronic device 100 to access various websites of the Internet. While applications 126 are shown including three applications, applications 126 can include more or fewer than three applications.

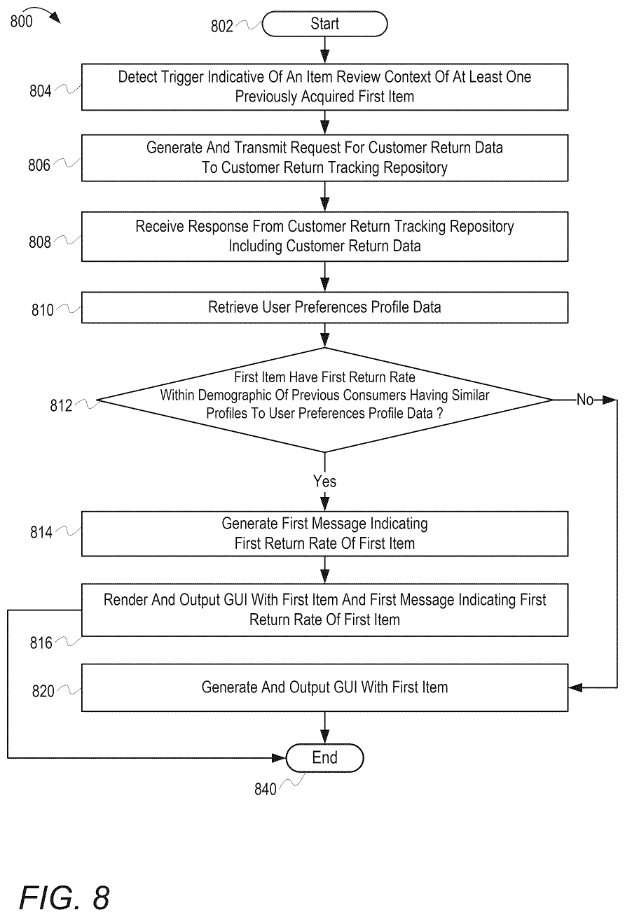

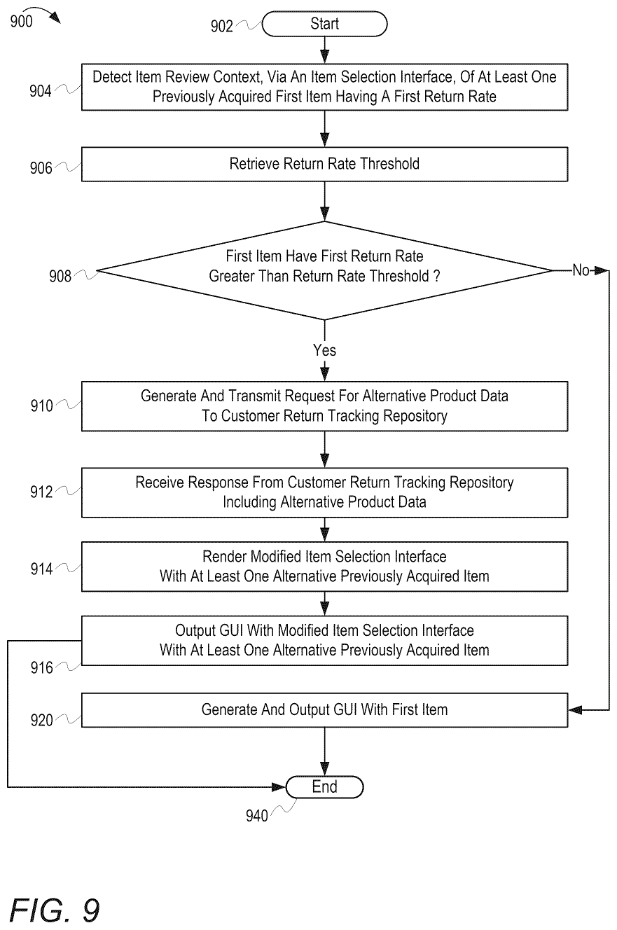

Return reduction module 128 includes program code that is executed by processor 102 to enable electronic device 100 to perform the various features of the present disclosure. In one or more embodiments, return reduction module 128 enables electronic device 100 to reduce incidents of returns of purchased/requested items. In one or more embodiments, execution of return reduction module 128 by processor 102 configures electronic device 100 to perform the processes presented in the flowcharts of FIGS. 8 and 9, as will be described below. Communication module 129 enables electronic device 100 to communicate and exchange data with other devices via wireless network 150 and/or WiFi router 196.

System memory 120 includes artificial intelligence (AI) engine 320 and contact data 322. AI engine 320 accelerates artificial intelligence, natural language processing (NLP), context evaluation (CE), and machine learning applications. Contact data 322 is a directory or list of known family members, friends and workers including e-mail addresses, messaging addresses and phone numbers.

System memory 120 includes user preferences profile data 330 about a user of electronic device 100. User preferences profile data 330 includes demographic data 332, shopping behavior data 334, and inferred indicator data 336 about a user of electronic device 100. Demographic data 332 can include a user profile of a user of electronic device 100 including age, gender, location (i.e., zip-code or city/state), occupation, income level, marital status (married or not married), and number of children, etc. Shopping behavior data 334 can include information from previous item orders, application activity, and payments. In an example embodiment, shopping behavior data 334 can include preferred pricing ranges for products/categories, frequency of ordering items, preferred sellers/brands, and sought after merchandise categories. Inferred indicator data 336 can include information from application activity, user profile changes, saved payment methods, application activity, and wish-lists. In an example embodiment, inferred indicator data 336 can include disposable income, profession, interests, attitudes towards product categories, and technical ability. In one embodiment, user preferences profile data 330 is correlated to acquiring items within one or more merchandise categories.

System memory 120 includes low return rate threshold 340 and high return rate threshold 342. Low return rate threshold 340 is a value of a return rate of a product, below which is considered an acceptable level of product returns. High return rate threshold 342 is a value of a return rate of a product, above which is considered an unacceptable level of product returns. In one embodiment, low return rate threshold 340 and high return rate threshold 342 can be pre-determined. In another embodiment, low return rate threshold 340 and high return rate threshold 342 can be dynamically determined depending upon return rates for a specific product category. In one or more embodiment, the values can be modified by the device user as a part of the user preferences profile data 330.

Turning to FIG. 3B, there is shown additional details of example contents of system memory 120 of electronic device 100 configured to complete the various processes described herein. System memory 120 includes customer return data 360. Electronic device 100 can receive customer return data 234 from customer return tracking repository 230 and store the received customer return data to system memory 120 as customer return data 360. Customer return data 360 contains data and information about items that have been returned to an online retailer or merchant by previous customers. In the example, customer return data 234 includes first item 362 and second item 364. While two items are shown in example customer return data 360, customer return data 360 can have more or less than two items.

First item 362 includes first item merchandise category and type 362A, first item name or identifier 362B, previous consumer preference (PCP) profile A 362C, and previous consumer preference (PCP) profile B 362G.

First item merchandise category and type 362A identifies the product or merchandise category and type associated with the first item 362. In an example embodiment, if the first item is a dress, the merchandise category can be women's clothing. In another example embodiment, if the first item is running shoes, the merchandise category can be footwear. First item identifier 362B is the name of the item. PCP profile A 362C and PCP profile B 362G are preference profile data that are associated with the previous consumers that have returned first item 362 after a purchase. In one embodiment, PCP profile A 362C and PCP profile B 364C can include at least some of demographic data, shopping behavior data, and/or inferred indicator data about previous consumers that have returned first item 362 after a purchase.

PCP profile A 362C includes demographic data A 362D, first item return rate A 362E, and first item return context A 362F. Demographic data A 362D is demographic information associated with previous consumers that have returned first item 362. Examples of demographic data include age, gender, location (i.e., zip-code or city/state), occupation, income level, marital status, and number of children. First item return rate A 362E is the return rate of first item 362 associated with previous consumers that have demographic data corresponding to demographic data A 362D. An example of first item return rate A 364E can be a 20 percent return rate. First item return context A 362F can include a reason for an item return or comments provided by previous consumers during the return of the first item. An example of first item return context A 362F can be that the previous customer thought the material was too thin and did not keep them warm. PCP profile B 362G includes demographic data B 362H, first item return rate B 362I, and first item return context B 362J.

Second item 364 includes second item merchandise category and type 364A, second item name or identifier 364B, previous consumer preference (PCP) profile C 364C, and previous consumer preference (PCP) profile D 364G. PCP profile C 364C includes demographic data C 364D, second item return rate C 364E, and second item return context C 364F. PCP profile D 364G includes demographic data D 364H, second item return rate D 364I, and second item return context D 364J.

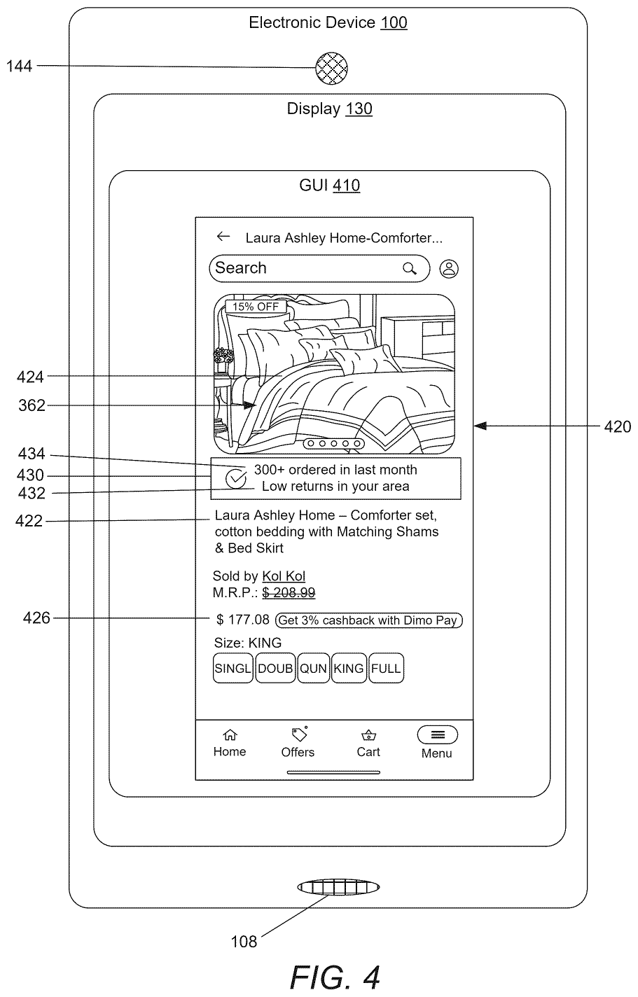

With reference to FIG. 4, electronic device 100 is shown with an example online item selection (OIS) graphical user interface (GUI) 410 presented on display 130 for reviewing and selecting items for possible acquisition by a user of electronic device 100. OIS GUI 410 allows a user of electronic device 100 to review and/or select/purchase goods and services from a merchant. In one embodiment, electronic device 100 can access a shopping website using shopping application 314 executing on processor 102. In one embodiment, OIS GUI 410 can result from a user of electronic device 100 searching an online shopping website for one or more desired items within a desired merchandise category and type (e.g., 1^{st} item merchandise category and type 362A).

OIS GUI 410 includes an online item selection interface page 420 that includes an item review context of an item (e.g. first item 362) that has been searched for/reviewed by at least one user. Online item selection interface page 420 includes first item 362, a description 422 of the first item, an image 424 of the first item, a price of the first item 426, and a notification or message 430 that indicates a return rate for the first item 362. Message 430 includes first item return rate 432 and first item return context 434. First item return rate 432 is the return rate of the first item by previous consumers that had previously acquired the first item.

In one embodiment, first item return rate 432 can indicate a range of the return rate (i.e., high, low or normal) for a geographical area where the user of electronic device 100 is located. In one embodiment, the geographical area where the user of electronic device 100 is located can be a zip-code. In another embodiment, first item return rate 432 can be a specific numerical value (e.g. 7 percent of the first items purchased are returned). In one embodiment, first item return context 434 can include the number (e.g., 15) of first items 362 that have been ordered and/or returned in a recent time period. In an embodiment, message 430 can be presented concurrently with presenting first item 362 on display 130.

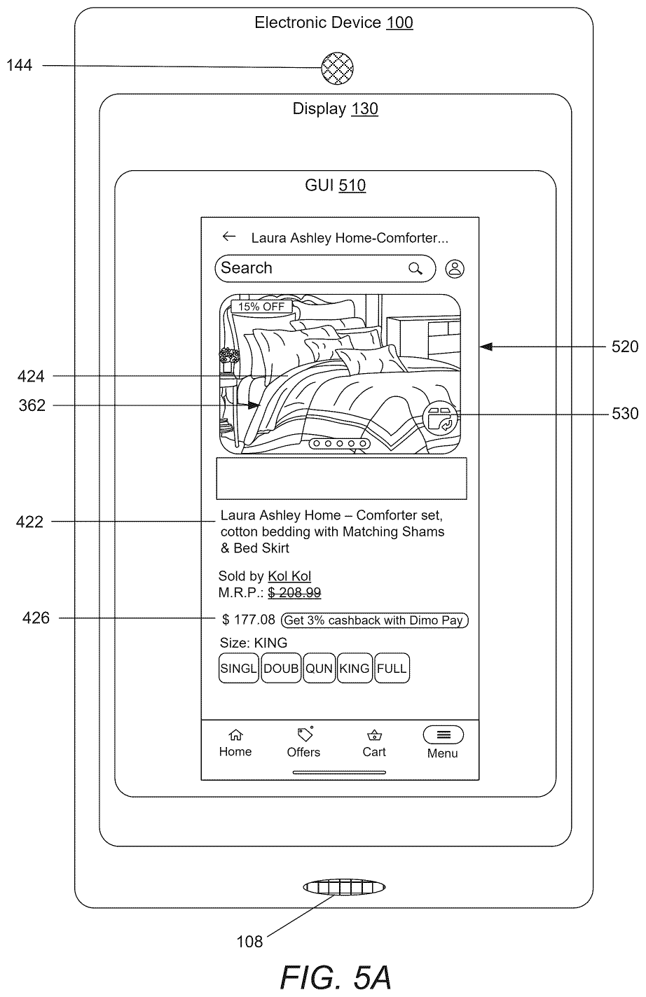

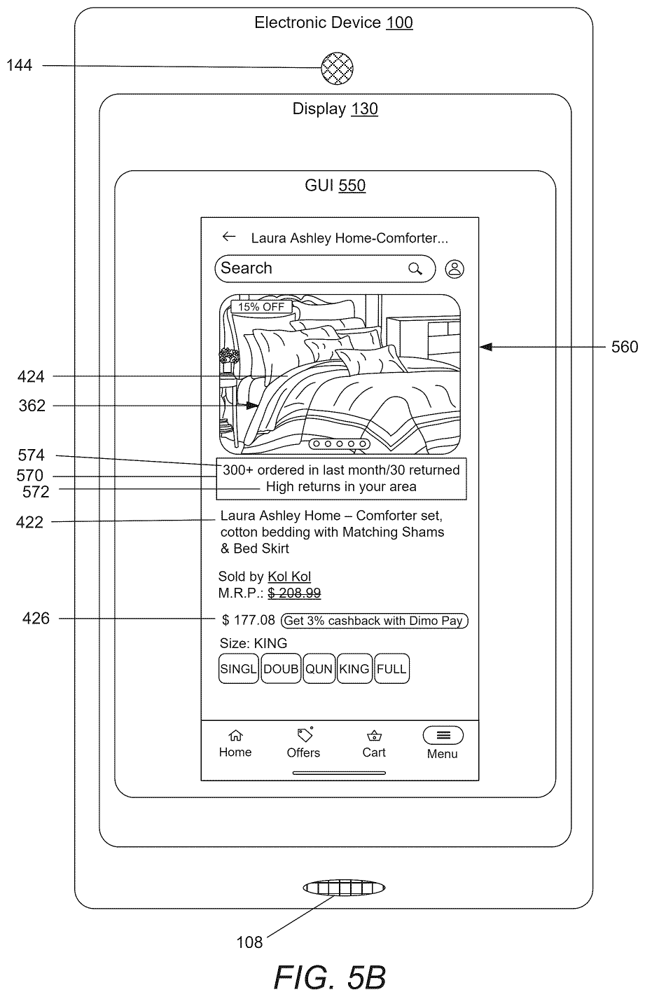

With reference to FIG. 5A, electronic device 100 is shown with an example online item selection (OIS) graphical user interface (GUI) 510 presented on display 130 for reviewing and selecting items for possible acquisition by a user of electronic device 100. OIS GUI 510 allows a user of electronic device 100 to review and/or select/purchase goods and services from a merchant.

OIS GUI 510 includes an online item selection interface page 520 that includes an item review context of an item (e.g. first item 362) that has been searched for/reviewed by at least one user. Online item selection interface page 520 includes first item 362, a description 422 of the first item, an image 424 of the first item, a price of the first item 426, and a user-selectable option 530 to present a message visually indicating the first return rate of the at least one previously-acquired first item.

Turning to FIG. 5B, electronic device 100 is shown with an example return message (RM) graphical user interface (GUI) 550 presented on display 130 after user-selectable option 530 of FIG. 5A has been selected. RM GUI 550 includes an online item selection interface page 560 that includes an item review context of an item (e.g. first item 362) that has been searched for/reviewed by at least one user. Online item selection interface page 560 includes first item 362, a description 422 of the first item, an image 424 of the first item, a price of the first item 426 and a notification or message 570 that indicates a return rate for the first item 362. Message 570 includes first item return rate 572 and first item return context 574. First item return rate 572 is the return rate of the first item by previous consumers that had previously acquired the first item. In one embodiment, first item return context 574 can include the number of first items 362 that have been ordered in a recent time period and the number that have been returned. In an embodiment, message 570 can be presented concurrently with presenting first item 362 on display 130.

According to one aspect of the disclosure, electronic device 100 can detect a trigger indicative of an item review context that includes a presentation of at least one first item 362 having a first merchandise category 362A and which was previously acquired by at least one previous consumer. In response to detecting the trigger, electronic device 100 retrieves customer return data 360 corresponding to the at least one first item 362. Electronic device 100 retrieves user preferences profile data 330 correlated to acquiring items within the first merchandise category. Electronic device 100 determines if the customer return data 360 indicates that the at least one first item 362 has a first return rate (e.g., first return rate A 362E) within a demographic of previous consumers having similar profiles (e.g., PCP profile A 362C) as that presented by the user preferences profile data 330. This process can include receiving a value of a return rate and comparing the value to a threshold return rate that is the first return rate A 362E. In response to the at least one first item 362 having a return rate that is or above the first return rate (e.g., first return rate A 362E), electronic device 100 outputs at least one of an indication or a first message 430 concurrently with presenting the at least one first item for review or selection. The first message 430 indicates that the at least one first item 362 has a return rate that is or exceeds first return rate A 362E.

According to another aspect of the disclosure, the first message 430 includes the first return rate 572 of the at least one first item 362 and a first context 574 associated with the first return rate. The first context 574 comprises customer provided information (e.g., reasons for return or feedback on the item or brand, etc.) associated with previous consumer returns of the at least one first item by previous consumers having similar profiles as that presented by the user preferences profile data 330.

According to an additional aspect of the disclosure, electronic device 100 includes at least one output device that comprises a display 130. To output the first message 570, electronic device 100 renders and outputs a first graphical user interface (GUI) 510 on the display. The first GUI 510 includes an item selection interface 520 having a representation of the at least one first item 362 and a first user-selectable option 530 to present the first message visually indicating the first return rate of the at least one previously-acquired first item.

According to one more aspect of the disclosure, electronic device 100 includes at least one output device that comprises a display 130. To output the first message 430, electronic device 100 renders and outputs a first graphical user interface (GUI) 410 on the display. The first GUI 410 includes an item selection interface 420 having a representation of the at least one first item 362 and the first message 430 visually indicating the return rate (e.g., first return rate 432) of the at least one previously-acquired first item.

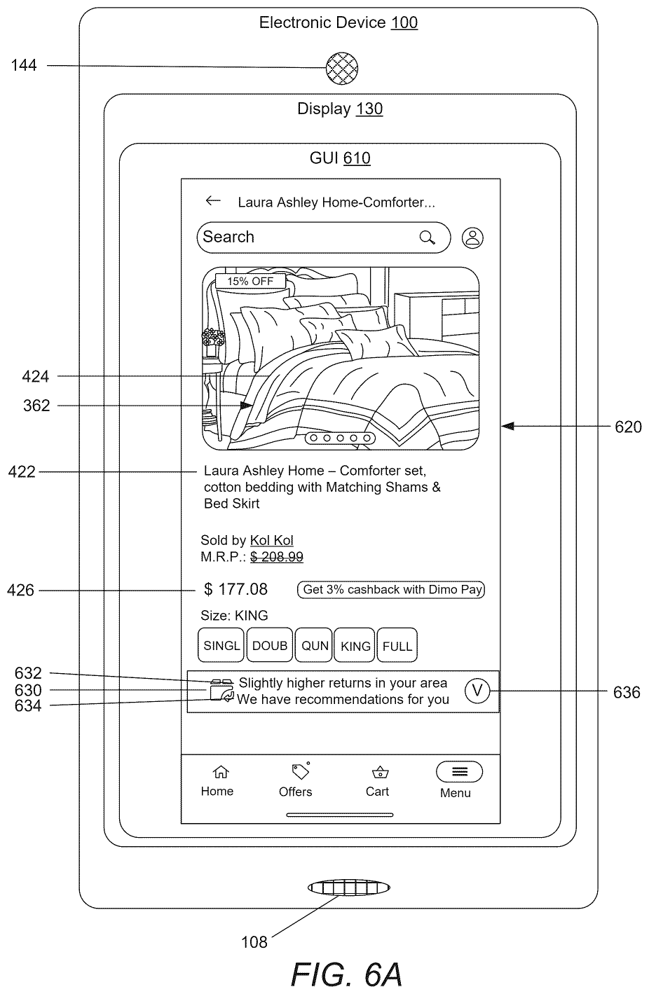

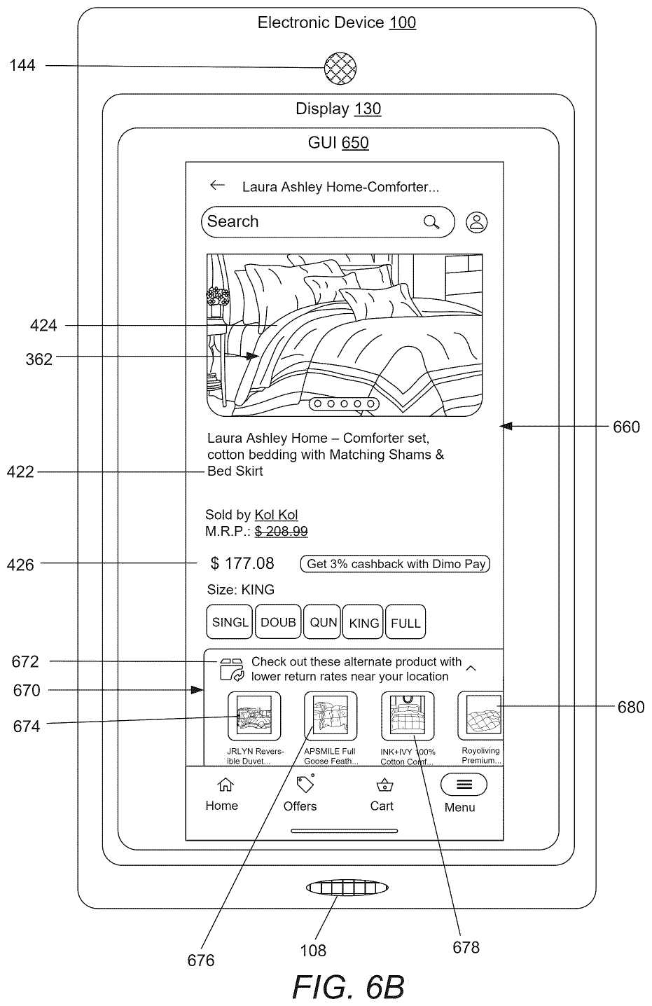

Referring to FIG. 6A, electronic device 100 is shown with an example online item selection (OIS) graphical user interface (GUI) 610 presented on display 130 for reviewing and selecting items for possible acquisition by a user of electronic device 100. OIS GUI 610 allows a user of electronic device 100 to review and/or select/purchase goods and services from a merchant. OIS GUI 610 includes an online item selection interface page 620 that includes an item review context of an item (e.g. first item 362) that has been searched for/reviewed by at least one user. Online item selection interface page 620 includes first item 362, a description 422 of the first item, an image 424 of the first item, a price of the first item 426, a return rate message 630, and a user-selectable option 636 to present alternative product recommendations with lower return rates than the return rate of the item being viewed presently (e.g., first item 362). Return rate message 630 includes first item return rate 632 and a notification 634 that alternative product recommendations with a lower return rate are available.

Turning to FIG. 6B, electronic device 100 is shown with an example alternative product recommendation (APR) graphical user interface (GUI) 650 presented on display 130 after user-selectable option 636 of FIG. 6A has been selected. APR GUI 650 includes an alternative product selection interface page 660 that includes an item review context of an item (e.g. first item 362) that has been searched for/reviewed by at least one user. Alternative product selection interface page 660 includes first item 362, a description 422 of the first item, an image 424 of the first item, a price of the first item 426, and a notification or message 670 that indicates alternative product recommendations.

Message 670 includes a description 672 of alternative product recommendations with lower return rates than the return rate for the first item 362. Message 670 further includes first alternative product recommendation 674, second alternative product recommendation 676, third alternative product recommendation 678, and fourth alternative product recommendation 680. Each alternative product recommendation 674-680 has a return rate that is less than lower return rate threshold 340.

According to one aspect of the disclosure, electronic device 100 can determine if the first return rate (e.g., first item return rate A 362E) associated with the at least one first item 362 is greater than a first return rate threshold 340. In response to determining that the first return rate associated with the at least one first item is greater than the first return rate threshold 340, electronic device 100 transmits, to a customer return tracking repository 230, a request for alternative product data 236 having the first merchandise category 362A and a third return rate that is less than the first return rate threshold 340. The alternative product data 236 includes at least one alternative previously-acquired item (e.g., first alternative product recommendation 674). In response to receiving the alternative product data, electronic device 100 renders a modified item selection interface (e.g., alternative product selection interface page 660) having the at least one alternative previously-acquired item (e.g., first alternative product recommendation 674). Electronic device 100 outputs the modified item selection interface on the display 130 to present the at least one alternative previously-acquired item for user consideration and possible selection.

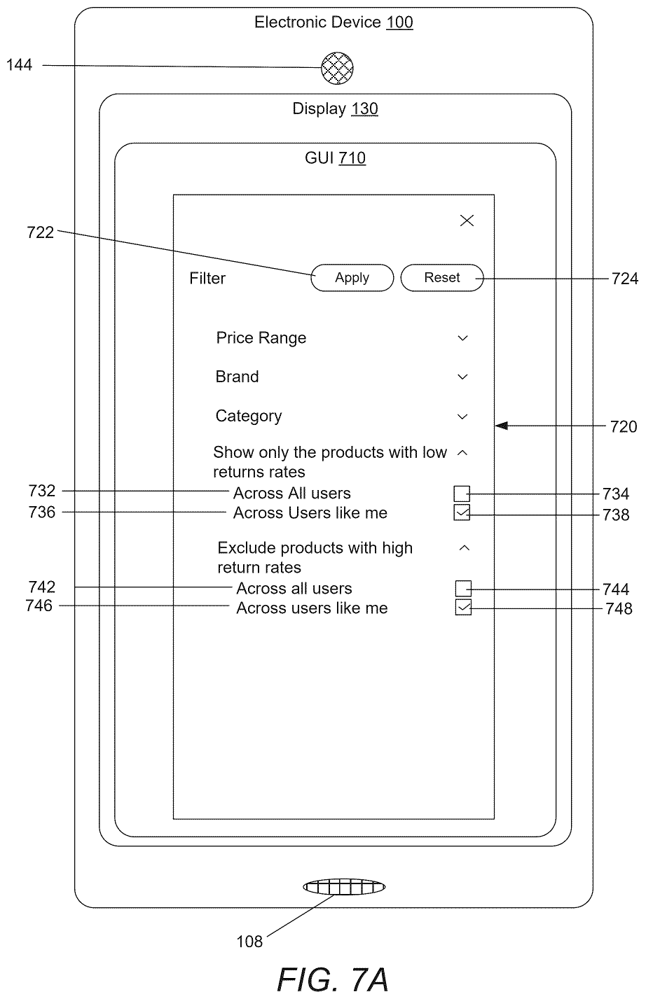

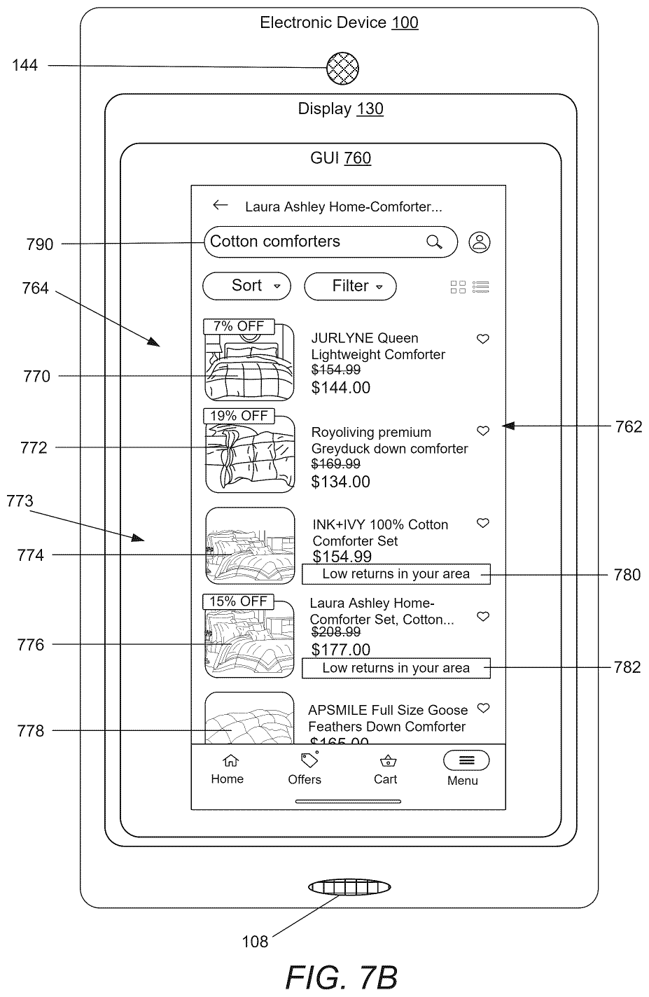

With reference to FIG. 7A, electronic device 100 is shown with an example filter selection (FS) graphical user interface (GUI) 710 presented on display 130. FS GUI 710 enables a user to select one or more filter types to be applied to multiple items of an online item selection interface page in order to remove/exclude items with high return rates or to only show items with low return rates (e.g., below a preset return rate threshold or a device-established or user-established return rate threshold). FS GUI 710 includes a filter interface page 720 with several user selectable options to select a filter type. Each selectable option has an associated on/off indication that toggles on when the listed filter type is selected. FS GUI 710 includes user-selectable apply filter option 722 and reset filter option 724.

FS GUI 710 includes option descriptions to only show products with low return rates across all users 732, only show products with low return rates across users like me 736, exclude products with high return rates across all users 742, and exclude products with high return rates across users like me 746, with respective option on/off indication 734, 738, 744, 748.

In FIG. 7A, option descriptions only show products with low return rates across users like me 736 and exclude products with high return rates across users like me 746 have been selected with respective option on/off indications 738 and 748 filled in or checked.

Turning to FIG. 7B, electronic device 100 is shown with an example online item selection after filtering (OISAF) graphical user interface (GUI) 760 presented on display 130. OISAF GUI 760 includes items that remain after the filter types selected in FIG. 7A have been applied. OISAF GUI 760 includes a modified online item selection interface page 762 presenting a set of previously-acquired items 764 with a selected filter type. In one embodiment, a user can input a desired search item into search field 790 to perform an online search for items having a desired merchandise category and type. In FIG. 7B, search field 790 is shown with a desired search item of “Cotton Comforters”. The search result items can have return rates that are higher and lower than a return rate threshold. The filter types selected in FIG. 7A can be applied to the search results to obtain the set of previously-acquired items 764 with a selected filter type.

The set of previously-acquired items 764 includes item A 770, item B 772, item C 774, item D 776, and item E 778. The set of previously-acquired items 764 includes a subset of previously-acquired items 773 that have a return rate that is less than the low return rate threshold 340. Subset of previously-acquired items 773 includes item C 774 and item D 776. Item C 774 is shown with a message 780 indicating a low return rate by previous consumers in the geographical area where a user of electronic device 100 is located. Item D 776 is shown with a message 782 indicating a low return rate by previous consumers in the geographical area where a user of electronic device 100 is located. In FIG. 7B, products with high return rates have been excluded or removed from the results of an online search for items having a desired merchandise category and type. The items that were removed have been replaced with items that were the result of an online search for a desired merchandise category and type.

In one embodiment, modified online item selection interface page 762 can include a set of previously-acquired items 764 from among a plurality of similar previously-acquired items that have a return rate that is less than low return rate threshold 340. In an embodiment, modified online item selection interface page 762 can exclude previously-acquired items from among a plurality of similar previously-acquired items that have a return rate that is greater than high return rate threshold 342. In one embodiment, item A 770, item B 772, and item C 774 can have return rates that are between low return rate threshold 340 and high return rate threshold 342 and are included in the set of previously-acquired items 764 presented without a return rate message.

According to one aspect of the disclosure, electronic device 100 can present, within the item selection interface, a second user-selectable option 736 to filter a plurality of similar previously-acquired items based on a first return rate threshold (e.g., low return rate threshold 340). In response to detecting selection of the second user-selectable option 736, electronic device 100 transmits, to a customer return tracking repository 230, a request for a first set of previously-acquired items from among the plurality of similar previously-acquired items that have a return rate that is less than the first return rate threshold (e.g., low return rate threshold 340). In response to receiving the first set of previously-acquired items 773, electronic device 100 renders a modified item selection interface 760 comprising the first set of previously-acquired items 773. Electronic device 100 outputs the modified item selection interface 760 on the display 130 to present the first set of previously-acquired items that have a return rate that is less than the first return rate threshold.

According to another aspect of the disclosure, electronic device 100 can present, within the item selection interface, a third user-selectable option 742 to filter a plurality of similar previously-acquired items based on a second return rate threshold (e.g., high return rate threshold 342). In response to detecting selection of the second user-selectable option 742, electronic device 100 transmits, to a customer return tracking repository 230, a request for a second set of previously-acquired items from among the plurality of similar previously-acquired items that have a return rate that is greater than the second return rate threshold (e.g., high return rate threshold 342). In response to receiving the second set of previously-acquired items, electronic device 100 removes the second set of previously-acquired items from the plurality of similar previously-acquired items to obtain a remaining set of previously-acquired items 764. Electronic device 100 renders a modified item selection interface 762 comprising the remaining set of previously-acquired items 764. Electronic device 100 outputs the modified item selection interface 762 on the display 130 to present the remaining set of previously-acquired items 764.

FIG. 8 depicts method 800 by which electronic device 100 presents a return rate message with a return rate of at least one item that was previously-acquired by a previous consumer. FIG. 9 depicts method 900 by which electronic device 100 identifies and presents alternative products/items with return rates below a return rate threshold.

The description of methods 800 and 900 will be described with reference to the components and examples of FIGS. 1-7B. The operations depicted in FIGS. 8 and 9 can be performed by electronic device 100 or any suitable electronic device that includes the one or more functional components of electronic device 100 that provide/enable the described features. One or more of the processes of the methods described in FIGS. 8 and 9 may be performed by processor 102 executing program code associated with return reduction module 128.

With specific reference to FIG. 8, method 800 begins at the start block 802. At block 804, method 800 includes detecting a trigger that is indicative of an item review context that includes a presentation of at least one previously acquired first item (e.g., item 362) having a first merchandise category 362A, and which was previously acquired by a previous consumer. In response to detecting the trigger, method 800 includes generating and transmitting a request 260 to customer return tracking repository 230 for customer return data 234 (block 806). Method 800 includes receiving a response 262 from customer return tracking repository 230 including the customer return data 234 (block 808). The received customer return data 234 is stored as customer return data 360 to system memory 120. Method 800 includes retrieving user preferences profile data 330 from system memory 120 (block 810).

At decision block 812, method 800 includes determining if the customer return data 360 indicates that the at least one first item 362 has a first return rate (e.g., first return rate A 362E) within a demographic of previous consumers having similar profiles (e.g., PCP profile A 362C) as that presented by the user preferences profile data 330. In response to determining that the customer return data 360 does not have a first return rate (e.g., first return rate A 362E) within a demographic of previous consumers having similar profiles (e.g., PCP profile A 362C) as that presented by the user preferences profile data 330, method 800 includes generating and outputting a GUI, to display 130, to present the at least one previously acquired first item (e.g., item 362) (block 820). Alternatively, method 800 may transition directly from block 812 to end block 840 at which method 800 terminates.

In response to determining that the customer return data 360 has a first return rate (e.g., first return rate A 362E) within a demographic of previous consumers having similar profiles (e.g., PCP profile A 362C) as that presented by the user preferences profile data 330, method 800 includes generating a first message 430 indicating the first return rate 432 (e.g., first return rate A 362E) of first item 362 (block 814). In one embodiment, user preferences profile data 330 substantially matches PCP profile A 362C in order to identify the first return rate A 362E associated with first item 362. In other words, first message 430 is generated when the user profile (e.g, user preferences profile data 330) of a user of electronic device 100 substantially matches PCP profile A 362C associated with previous consumers that have returned first item 362 after a purchase.

Method 800 includes rendering and outputting a GUI 410, to display 130, to present first message 430 concurrently with presenting the at least one first item 362 for review or selection (block 816). The first message 430 includes/indicates the first return rate 432 (e.g., first return rate A 362E) of the at least one first item 362 and can include additional contextual information associated with the returns by the previous customers. Method 800 ends at end block 840.

FIG. 9 depicts method 900 by which electronic device 100 identifies and presents alternative products/items with return rates below a return rate threshold. With specific reference to FIG. 9, method 900 begins at the start block 902. At block 904, method 900 includes detecting an item review context, via an item selection interface 620, of at least one previously acquired first item (e.g., item 362) that has a first return rate (e.g., first return rate A 362E). In response to detecting the item review context of the previously acquired first item having a first return rate, method 900 includes retrieving low return rate threshold 340 (block 906). At decision block 908, method 900 includes determining if the first return rate (e.g., first item return rate A 362E) associated with the at least one first item 362 is greater than low return rate threshold 340. The first item return rate A 362E being greater than the low return rate threshold 340, indicates that the item being reviewed (e.g., item 362) was frequently returned by previous purchasers.

In response to determining that the first return rate (e.g., first return rate A 362E) associated with the at least one first item is not greater than the low return rate threshold 340, method 900 includes generating and outputting a GUI, to display 130, to present the at least one previously acquired first item (e.g., item 362) (block 920). Method 900 terminates at end block 940.

In response to determining that the first return rate associated with the at least one first item is greater than the low return rate threshold 340, method 900 includes generating and transmitting, to a customer return tracking repository 230, a request 260 for alternative product data 236 having the first merchandise category 362A and a third return rate that is less than the low return rate threshold 340 (block 910). Method 900 includes receiving a response 262, from customer return tracking repository 230, including the alternative product data 236 (block 912). The alternative product data 236 includes at least one alternative previously-acquired item (e.g., first alternative product recommendation 674) having the first merchandise category 362A and a return rate that is less than low return rate threshold 340. The alternative product recommendations provide alternative item/product options to a user with lower return rates.

In response to receiving the alternative product data 236, method 900 includes rendering a modified item selection interface (e.g., alternative product selection interface 660) comprising the at least one alternative previously-acquired item (e.g., first alternative product recommendation 674) (block 914). Method 900 includes outputting a GUI with the modified item selection interface 660 on the display 130 to present the at least one alternative previously-acquired item (e.g., first alternative product recommendation 674) (block 916). Method 900 ends at end block 940.

The disclosure provides a user of an electronic device an improved online shopping experience through the reduction of returns of purchased/requested items acquired through online shopping. The disclosure enables a user of an electronic device to view return rates and return information of items that were previously-acquired by a previous consumer or customer. The disclosure enables a user of an electronic device to view return rates and return information of items associated with previous consumers having a consumer preferences profile that is substantially similar to a user preferences profile of the user of the electronic device. The disclosure enables a user of an electronic device to choose one or more types of filters to select a plurality of similar items based on at least one return rate. The disclosure facilitates an improved online shopping experience by providing an electronic device user with alternative product recommendations based on return rates for items that were previously-acquired by a previous consumer. The disclosure increases customer satisfaction with online shopping by providing return rate information for items that were previously-acquired by a previous consumer during an online shopping session.

In the above-described methods of FIGS. 8 and 9, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
at least one output device;
a communications subsystem that enables the electronic device to connect to external networks and devices;
a memory having stored thereon a return reduction module for reducing incidents of returns of purchased/requested items; and
at least one processor communicatively coupled to each of the at least one output device, the communications subsystem, and the memory, and which executes program code of the return reduction module, the at least one processor configured to cause the electronic device to:
detect a trigger indicative of an item review context that includes a presentation of at least one first item having a first merchandise category and which was previously acquired by a previous consumer;
in response to detecting the trigger, retrieve customer return data corresponding to the at least one first item;
retrieve user preferences profile data correlated to acquiring items within the first merchandise category;
determine if the customer return data indicates that the at least one first item has a first return rate within a demographic of previous consumers having similar profiles as that presented by the user preferences profile data; and
in response to the at least one first item having the first return rate, output at least one of an indication or a first message concurrently with presenting the at least one first item for review or selection, the first message indicating the first return rate of the at least one first item.

2. The electronic device of claim 1, wherein the at least one processor is configured to:
generate a request for the customer return data;
transmit the request for the customer return data to a customer return tracking repository; and
receive, from the customer return tracking repository, the customer return data.

3. The electronic device of claim 1, wherein the first message includes the first return rate of the at least one first item and a first context associated with the first return rate, the first context comprising customer return information associated with previous consumer returns of the at least one first item by previous consumers having similar profiles as that presented by the user preferences profile data.

4. The electronic device of claim 1, wherein the at least one output device comprises a display and to output the indication, the at least one processor is configured to:
output a first graphical user interface (GUI) on the display, the first GUI including an item selection interface comprising a representation of the at least one first item and a first user-selectable option to present the first message visually indicating the first return rate of the at least one previously-acquired first item.

5. The electronic device of claim 1, wherein the at least one output device comprises a display and to output the first message, the at least one processor is configured to:
output a first graphical user interface (GUI) on the display, the first GUI including an item selection interface comprising a representation of the at least one first item and the first message visually indicating the first return rate of the at least one previously-acquired first item.

6. The electronic device of claim 5, wherein:
the at least one first item is among a plurality of similar previously-acquired items within the first merchandise category; and
the at least one processor is configured to:
present within the item selection interface a second user-selectable option to filter the plurality of similar previously-acquired items based on a first return rate threshold; and
in response to detecting selection of the second user-selectable option:
transmit, to a customer return tracking repository, a request for a first set of previously-acquired items from among the plurality of similar previously-acquired items that have a return rate that is less than the first return rate threshold;
in response to receiving the first set of previously-acquired items, render a modified item selection interface comprising the first set of previously-acquired items; and
output the modified item selection interface on the display to present the first set of previously-acquired items that have a return rate that is less than the first return rate threshold.

7. The electronic device of claim 5, wherein:
the at least one first item is among a plurality of similar previously-acquired items within the first merchandise category; and
the at least one processor is configured to:
present within the item selection interface a third user-selectable option to filter the plurality of similar previously-acquired items based on a second return rate threshold; and
in response to detecting selection of the third user-selectable option:
transmit, to a customer return tracking repository, a request for a second set of previously-acquired items from among the plurality of similar previously-acquired items that have a return rate that is greater than the second return rate threshold;
in response to receiving the second set of previously-acquired items, remove the second set of previously-acquired items from the plurality of similar previously-acquired items to obtain a remaining set of previously-acquired items;
render a modified item selection interface comprising the remaining set of previously-acquired items; and
output the modified item selection interface on the display to present the remaining set of previously-acquired items.

8. The electronic device of claim 5, wherein the at least one processor is configured to:
determine if the first return rate associated with the at least one first item is greater than a first return rate threshold; and
in response to determining that the first return rate associated with the at least one first item is greater than the first return rate threshold:
transmit, to a customer return tracking repository, a request for alternative product data having the first merchandise category and a third return rate that is less than the first return rate threshold, the alternative product data including at least one alternative previously-acquired item;
in response to receiving the alternative product data, render a modified item selection interface comprising the at least one alternative previously-acquired item; and
output the modified item selection interface on the display to present the at least one alternative previously-acquired item.

9. A method comprising:
detecting, via at least one processor of an electronic device, a trigger indicative of an item review context that includes a presentation of at least one first item having a first merchandise category and which was previously acquired by a previous consumer;
in response to detecting the trigger, retrieving customer return data corresponding to the at least one first item;
retrieving user preferences profile data correlated to acquiring items within the first merchandise category;
determining if the customer return data indicates that the at least one first item has a first return rate within a demographic of previous consumers having similar profiles as that presented by the user preferences profile data; and
in response to the at least one first item having the first return rate, outputting at least one of an indication or a first message concurrently with presenting the at least one first item for review or selection, the first message indicating the first return rate of the at least one first item.

10. The method of claim 9, further comprising:
generating a request for the customer return data;
transmitting the request for the customer return data to a customer return tracking repository; and
receiving, from the customer return tracking repository, the customer return data.

11. The method of claim 9, wherein the first message includes the first return rate of the at least one first item and a first context associated with the first return rate, the first context comprising customer return information associated with previous consumer returns of the at least one first item by previous consumers having similar profiles as that presented by the user preferences profile data.

12. The method of claim 9, wherein the electronic device further comprises a display and to output the indication, the method further comprises:
outputting a first graphical user interface (GUI) on the display, the first GUI including an item selection interface comprising a representation of the at least one first item and a first user-selectable option to present the first message visually indicating the first return rate of the at least one previously-acquired first item.

13. The method of claim 9, wherein the electronic device further comprises a display and to output the first message, the method further comprises:
output a first graphical user interface (GUI) on the display, the first GUI including an item selection interface comprising a representation of the at least one first item and the first message visually indicating the first return rate of the at least one previously-acquired first item.

14. The method of claim 13, wherein:
the at least one first item is among a plurality of similar previously-acquired items within the first merchandise category; and
the method further comprises:
presenting within the item selection interface a second user-selectable option to filter the plurality of similar previously-acquired items based on a first return rate threshold; and
in response to detecting selection of the second user-selectable option:
transmitting, to a customer return tracking repository, a request for a first set of previously-acquired items from among the plurality of similar previously-acquired items that have a return rate that is less than the first return rate threshold;
in response to receiving the first set of previously-acquired items, rendering a modified item selection interface comprising the first set of previously-acquired items; and
outputting the modified item selection interface on the display to present the first set of previously-acquired items that have a return rate that is less than the first return rate threshold.

15. The method of claim 13, wherein:
the at least one first item is among a plurality of similar previously-acquired items within the first merchandise category; and
the method further comprises:
presenting within the item selection interface a third user-selectable option to filter the plurality of similar previously-acquired items based on a second return rate threshold; and
in response to detecting selection of the third user-selectable option:
transmitting, to a customer return tracking repository, a request for a second set of previously-acquired items from among the plurality of similar previously-acquired items that have a return rate that is greater than the second return rate threshold;
in response to receiving the second set of previously-acquired items, removing the second set of previously-acquired items from the plurality of similar previously-acquired items to obtain a remaining set of previously-acquired items;
rendering a modified item selection interface comprising the remaining set of previously-acquired items; and
outputting the modified item selection interface on the display to present the remaining set of previously-acquired items.

16. The method of claim 13, further comprising:
determining if the first return rate associated with the at least one first item is greater than a first return rate threshold; and
in response to determining that the first return rate associated with the at least one first item is greater than the first return rate threshold:
transmitting, to a customer return tracking repository, a request for alternative product data having the first merchandise category and a third return rate that is less than the first return rate threshold, the alternative product data including at least one alternative previously-acquired item;
in response to receiving the alternative product data, rendering a modified item selection interface comprising the at least one alternative previously-acquired item; and
outputting the modified item selection interface on the display to present the at least one alternative previously-acquired item.

17. A computer program product comprising:
a computer readable storage device having stored thereon program code which, when executed by at least one processor of an electronic device having at least one output device, and a communications subsystem, configures the electronic device to complete the functionality of:
detecting a trigger indicative of an item review context that includes a presentation of at least one first item having a first merchandise category and which was previously acquired by a previous consumer;
in response to detecting the trigger, retrieving customer return data corresponding to the at least one first item;
retrieving user preferences profile data correlated to acquiring items within the first merchandise category;
determining if the customer return data indicates that the at least one first item has a first return rate within a demographic of previous consumers having similar profiles as that presented by the user preferences profile data; and
in response to the at least one first item having the first return rate, outputting at least one of an indication or a first message concurrently with presenting the at least one first item for review or selection, the first message indicating the first return rate of the at least one first item.

18. The computer program product of claim 17, wherein the program code further configures the electronic device to complete the functionality of:
generating a request for the customer return data;
transmitting the request for the customer return data to a customer return tracking repository; and
receiving, from the customer return tracking repository, the customer return data.

19. The computer program product of claim 17, wherein the first message includes the first return rate of the at least one first item and a first context associated with the first return rate, the first context comprising customer return information associated with previous consumer returns of the at least one first item by previous consumers having similar profiles as that presented by the user preferences profile data.

20. The computer program product of claim 17, wherein the at least one output device comprises a display and to output the indication, the program code further configures the electronic device to complete the functionality of:
determining if the first return rate associated with the at least one first item is greater than a first return rate threshold; and
in response to determining that the first return rate associated with the at least one first item is greater than the first return rate threshold:
transmitting, to a customer return tracking repository, a request for alternative product data having the first merchandise category and a third return rate that is less than the first return rate threshold, the alternative product data including at least one alternative previously-acquired item;
in response to receiving the alternative product data, rendering a modified item selection interface comprising the at least one alternative previously-acquired item; and
outputting the modified item selection interface on the display to present the at least one alternative previously-acquired item.
